(19) United States
(12) Patent Application Publication
(10) Pub. No.: US 2010/0042921 A1
(43) Pub. Date: Feb. 18, 2010

(54) SYSTEM AND METHOD FOR VIEWING SOFTWARE HELP DOCUMENTATION

(75) Inventors: CHIH-KUANG CHANG, Tu-Cheng (TW); LI JIANG, Shenzhen City (CN); ZHONG-KUI YUAN, Shenzhen City (CN); JUN GUO, Shenzhen City (CN); YAN-LI LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/485,029

(22) Filed: Jun. 15, 2009

(30) Foreign Application Priority Data
Aug. 15, 2008 (CN) 200810303891.2

(51) Int. Cl. G06F 3/048; G06F 3/00

(52) U.S. Cl. 715/711; 715/714

(57) ABSTRACT

A system and method for viewing software help documentation obtains a feature name of a current interface of a software and a position of a cursor in the current interface, and receives a control command to invoke a help system of the software. The system and method further displays the help document of the help option corresponding to the position of the cursor in the current interface on a display device, in response to a determination that the help system comprises the feature name of the current interface, and further comprises a help option corresponding to the position of the cursor in the current interface.

### BACKGROUND

1. Technical Field

Embodiments of the present disclosure relate to file management systems and methods, and particularly to a system and method for viewing software help documentation.

2. Description of Related Art

A help system (sometimes called a help file) is an important part of software to help users understand features and capabilities of the software. The help system contains a plurality of help documents related to frequently asked questions (FAQs). Often, when the help system is opened, the help system goes into a default interface, causing a user to spend much time is spent in locating a desired help documentation.

Therefore, there is a need for a system and method which can overcome the above-mentioned problems.

### BRIEF DESCRIPTION OF THE DRAWINGS

FIG. 1 is a block diagram of one embodiment of a system for viewing software help documentation.

FIG. 2 is a flowchart of one embodiment of a method for viewing software help documentation.

FIG. 3 illustrates one embodiment of an interface of the software.

### DETAILED DESCRIPTION

All of the processes described below may be embodied in, and fully automated via, function modules executed by one or more general purpose computers or processors. The code modules may be stored in any type of computer-readable medium or other computer storage device. Some or all of the methods may alternatively be embodied in specialized computer hardware.

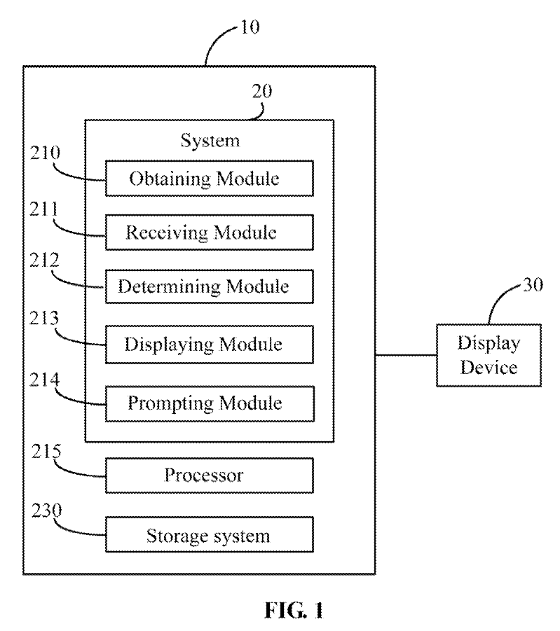

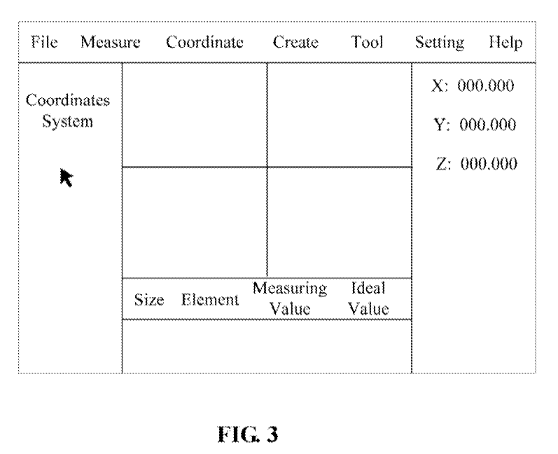

FIG. 1 is a block diagram of one embodiment of a computer 10 comprising a system 20 for viewing software help documentation in the computer 10. The computer 10 is connected to a power supply device 30. In one embodiment, the software help documentation may be related to, but not limited to, help documentation for a software application, such as an image measuring application software. One embodiment of an interface of the software is shown in FIG. 3. The computer 10 is operable to store a plurality of the software help documentations. In one embodiment, the help documentations may explain how to install and use the software, or explain the features and capabilities of the software. Each of the help documentations comprises an introduction of a corresponding interface of the software. The introduction may include, but not limited to, picture information and text information. In one embodiment, the computer 10 may be a personal computer (PC), a network server, and can also be any other appropriate data-processing equipment.

The display device 30 is operable to display the software help documentations. The help documentation may be viewed on the display device 30.

In one embodiment, the system 20 comprises an obtaining module 210, a receiving module 211, a determining module 212, a displaying module 213, and a prompting module 214. One or more computerized codes of the modules 210-214 are stored in the storage system 230. One or more general purpose or specialized processors, such as a processor 215 executes the computerized codes of the modules 210-214 to provide one or more operations of the system 20.

The obtaining module 210 is operable to obtain a feature name of a current interface of the software and a position of a cursor in the current interface. In one embodiment, each interface of the software corresponds to a feature name. For example, as shown FIG. 3, the feature name of the interface of the software is “Coordinates System.” The obtaining module 210 obtains the feature name “Coordinates System.” Additionally, the obtaining module 210 obtains a position of a cursor (such as an arrow) of a pointing device in the current interface. The pointing device may include a mouse, a track-pad, a touch screen, or a combination thereof.

The receiving module 211 is operable to receive a control command to invoke a help system of the software. In one embodiment, the control command is generated by pressing F1 key of a keyboard (not shown in FIG. 1) of the computer 10.

The determining module 212 is operable to determine if the help system includes the feature name of the current interface, and further determine if the help system includes a help option corresponding to the position of the cursor in the current interface. In one embodiment, as shown FIG. 3, the determining module 212 determines if the help system of the software includes the feature name “Coordinates System.”

The displaying module 213 is further operable to display a help documentation corresponding to the help option on the display device 30, in response to a determination that the help system includes the feature name of the current interface, and further includes a help option corresponding to the position of the cursor in the current interface. The help documentation corresponding to the help option explains the features of the current interface.

The prompting module 214 is operable to prompt a user to edit the help documentation of the current interface, in response to a determination that the help system does not include the feature name of the current interface, or the help system does not include a help option corresponding to the position of the cursor in the current interface. In one embodiment, the prompting module 214 pops up a dialog box to prompt the user to edit the help documentation of the current interface.

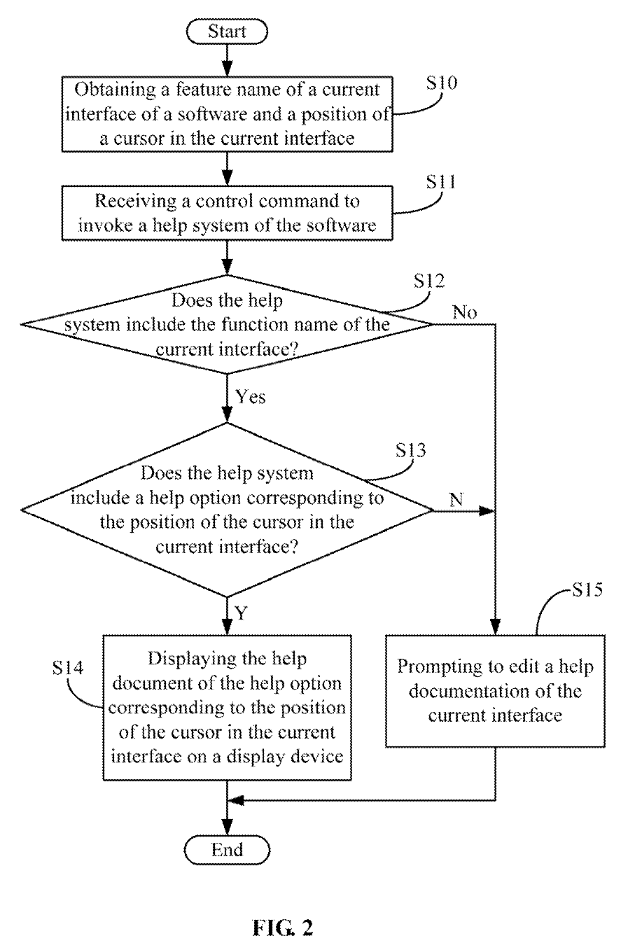

FIG. 2 is a flowchart of one embodiment of a method for viewing software help documentation. In block S 10, the obtaining module 210 obtains a feature name of a current interface of the software and a position of a cursor in the current interface. As mentioned above, as shown in FIG. 3, the obtaining module 210 obtains the feature name “Coordinates System” and obtains the position of the arrow in the interface.

In block S11, the receiving module 211 receives a control command to invoke a help system of the software. As mentioned above, the control command is generated by pressing F1 key of the keyboard of the computer 10.

In block S12, the determining module 212 determining if the help system includes the feature name of the current interface. As mentioned above, as shown FIG. 3, if the help system includes the feature name “Coordinates System,” then the procedure goes to S13. Otherwise, the procedure goes to block S15.

In block S13, the determining module 212 further determines if the help system includes a help option corresponding to the position of the cursor in the current interface, in response to a determination that the help system includes the feature name of the current interface. As mentioned above, if the help system includes a help option corresponding to the position of the cursor in the current interface, then the procedure goes to S14. Otherwise, the procedure goes to block S15.

In block S14, the displaying module 213 displays a help document corresponding to the help option on the display device 30, in response to a determination that the help system includes the feature name of the current interface, and further includes a help option corresponding to the position of the cursor in the current interface. As mentioned above, the help documentation corresponding to the help option explains the features of the current interface.

In block S15, the prompting module 214 prompts to edit a help documentation of the current interface, in response to a determination that the help system does not comprise the feature name of the current interface, or the help system does not include a help option corresponding to the position of the cursor in the current interface. As mentioned above, the prompting module 214 pops up a dialog box to prompt a user to edit the help documentation of the current interface. For example, the dialog box may contain, but not limited to, a message saying “The help documentation for the interface is not complete, please edit!”

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A software help documentation viewing system, the system comprising a storage system storing a plurality of programs and a processor that executes one or more operations for the plurality of programs, the programs comprising:
an obtaining module operable to obtain a feature name of a current interface of a software of the system, and a position of a cursor in the current interface, the interface being displayed on a display device of the system;
a receiving module operable to receive a control command to invoke a help system of the software;
a determining module to determine if the help system comprises the feature name of the current interface, and further determine if the help system comprises a help option corresponding to the position of the cursor in the current interface; and
a displaying module operable to display the help document of the help option corresponding to the position of the cursor in the current interface on the display device, in response to a determination that the help system comprises the feature name of the current interface, and further comprises a help option corresponding to the position of the cursor in the current interface.

2. The system of claim 1, wherein the control command is generated by pressing F1 key of a keyboard.

3. The system of claim 1, wherein the help documentation comprises an introduction of the current interface.

4. The system of claim 3, wherein the introduction comprises picture information and text information.

5. The system of claim 1, further comprising a prompting module operable to prompt a user to edit the help documentation of the current interface, in response to a determination that the help system does not comprise the feature name of the current interface, or the help system does not comprise a help option corresponding to the position of the cursor in the current interface.

6. A computer-implemented method for viewing software help documentation, the method comprising:
obtaining a feature name of a current interface of a software and a position of a cursor in the current interface, the interface being displayed on a display device of the system;
receiving a control command to invoke a help system of the software;
determining if the help system comprises the feature name of the current interface, and further determining if the help system comprises a help option corresponding to the position of the cursor in the current interface; and
displaying the help document of the help option corresponding to the position of the cursor in the current interface on the display device, in response to a determination that the help system includes the feature name of the current interface, and further comprise a help option corresponding to the position of the cursor in the current interface.

7. The method of claim 6, wherein the control command is generated by pressing the F1 key of a keyboard.

8. The method of claim 6, wherein the help documentation comprises picture information and text information.

9. The method of claim 8, wherein the introduction comprises a plurality of pictures and words.

10. The method of claim 8, further comprising:
prompting to edit a help documentation of the current interface, in response to a determination that the help system does not comprise the feature name of the current interface, or that the help system does not comprise a help option corresponding to the position of the cursor in the current interface.

11. A computer-readable medium having stored thereon instructions that, when executed by a computer, causing the computer to perform a method for viewing software help documentation, the method comprising:
obtaining a feature name of a current interface of a software and a position of a cursor in the current interface, the interface being displayed on a display device of the system;
receiving a control command to invoke a help system of the software;
determining if the help system comprises the feature name of the current interface, and further determining if the help system comprises a help option corresponding to the position of the cursor in the current interface; and
displaying the help document of the help option corresponding to the position of the cursor in the current interface on the display device, in response to a determination that the help system includes the feature name of the current interface, and further comprise a help option corresponding to the position of the cursor in the current interface.

12. The medium of claim 11, wherein the control command is generated by pressing F1 key of a keyboard.

13. The medium of claim 11, wherein the help documentation comprises picture information and text information.

14. The medium of claim 13, wherein the introduction comprises picture information and text information.

15. The medium of claim 11, wherein the method further comprises:
prompting to edit a help documentation of the current interface, in response to a determination that the help system does not comprise the feature name of the current interface, or that the help system does not comprise a help option corresponding to the position of the cursor in the current interface.
